(19) United States
(12) Patent Application Publication
(10) Pub. No.: US 2025/0023835 A1
(43) Pub. Date: Jan. 16, 2025

(54) DATA PROCESSING METHOD, ELECTRONIC DEVICE AND STORAGE MEDIUM

(71) Applicant: Beijing Zitiao Network Technology Co., Ltd., Beijing (CN)

(72) Inventors: Shu ZHANG, Beijing (CN); Yiqi WANG, Beijing (CN)

(21) Appl. No.: 18/768,874

(22) Filed: Jul. 10, 2024

(30) Foreign Application Priority Data
Jul. 14, 2023 (CN) 202310868257.8

(51) Int. Cl. H04L 51/046; G06Q 10/10; H04L 12/18

(52) U.S. Cl. CPC H04L 51/046; G06Q 10/103; H04L 12/1818; H04L 12/1822; H04L 12/1831

(57) ABSTRACT

A data processing method, an electronic device and a storage medium. For example, when a user associated with target data needs to be adjusted, a data transfer operation can be acquired first. The data transfer operation is used to change the associated user of the target data from a second user to a first user. The target data includes IM group chat data and/or video conference data of the second user. After the data transfer operation is acquired, an association relationship between the target data and the first user can be established.

### CROSS-REFERENCE TO RELATED APPLICATION(S)

This application claims priority to the Chinese patent application No. 202310868257.8 filed with the CNIPA on Jul. 14, 2023, which is incorporated in the present application by reference in its entirety.

### TECHNICAL FIELD

The present disclosure relates to the technical field of computers, in particular to a data processing method and apparatus, an electronic device, and a storage medium.

### BACKGROUND

In a real scenario, data may be associated with users. Users can view and/or edit the data associated therewith, and can also perform corresponding operations with the data associated therewith. In some scenarios, it may be necessary to adjust the association relationship between data and users. For example, in a flow process involving multiple links, it may be necessary to transfer data to a person in charge of a certain link. When there is a change in the employee's post, it may be necessary to transfer related data of the original employee in the post to the new employee in charge of the post.

However, at present, it mainly relies on technicians to manually adjust the association relationship between data and users, and there is no quick adjustment method.

### SUMMARY

In order to solve the problems in the prior art, embodiments of the present disclosure provide a data processing method and apparatus, an electrode device and a storage medium.

An embodiment of the present disclosure provides a data processing method, including:
acquiring a data transfer operation for changing an associated user of target data from a second user to a first user, wherein the target data includes instant messaging (IM) group chat data and/or video conference data of the second user; and
establishing an association relationship between the target data and the first user according to the data transfer operation.

In some possible implementations, the method further includes:
deleting an association relationship between the target data and the second user.

In some possible implementations, the target data includes the IM group chat data, and the IM group chat data includes an identifier of a target IM group chat. The establishing the association relationship between the target data and the first user according to the data transfer operation includes:
adjusting the first user to be a group member, an administrator or a group owner of the target IM group chat.

In some possible implementations, the target data includes the video conference data, and the video conference data includes at least one of a video of the video conference, an audio of the video conference or a text record of the video conference.

In some possible implementations, the establishing the association relationship between the target data and the first user according to the data transfer operation includes:
granting the first user an authority to access the video conference data or an authority to edit the video conference data.

In some possible implementations, the target data further includes document data corresponding to a target document;
the establishing the association relationship between the target data and the first user according to the data transfer operation includes:
granting the first user an authority to view the target document or an authority to edit the target document.

In some possible implementations, the target data further includes schedule data corresponding to a target schedule;
the establishing the association relationship between the target data and the first user according to the data transfer operation includes:
adding the first user to the target schedule.

In some possible implementations, the target data further includes application data corresponding to a target application program;
the establishing the association relationship between the target data and the first user according to the data transfer operation includes:
granting the first user an authority to use the target application program, or setting the first user as an administrator of the target application program.

In some possible implementations, the target data further includes questionnaire data corresponding to a target questionnaire;
the establishing the association relationship between the target data and the first user according to the data transfer operation includes:
granting the first user an authority to fill in the target questionnaire, or granting the first user an authority to manage the target questionnaire.

In some possible implementations, before acquiring the data transfer operation, the method further includes:
displaying resource data and candidates of the second user;
determining the target data in the resource data in response to a selection instruction, and determining the first user among the candidates.

An embodiment of the present disclosure further provides a data processing apparatus, including: an acquisition unit, configured to acquire a data transfer operation for changing an associated user of target data from a second user to a first user, wherein the target data includes instant messaging IM group chat data and/or video conference data of the second user; and an association relationship adjusting unit, configured to establish an association relationship between the target data and the first user according to the data transfer operation.

In some possible implementations, the association relationship adjusting unit is further configured to delete an association relationship between the target data and the second user.

In some possible implementations, the target data includes the IM group chat data, and the IM group chat data includes an identifier of a target IM group chat. The association relationship adjusting unit is configured to adjust the first user to be a group member, an administrator or a group owner of the target IM group chat.

In some possible implementations, the target data includes the video conference data, and the video conference data includes at least one of a video of the video conference, an audio of the video conference or a text record of the video conference.

In some possible implementations, the association relationship adjusting unit is configured to grant the first user an authority to access the video conference data or an authority to edit the video conference data.

In some possible implementations, the target data further includes document data corresponding to a target document. The association relationship adjusting unit is further configured to grant the first user an authority to view the target document or an authority to edit the target document.

In some possible implementations, the target data further includes schedule data corresponding to a target schedule. The association relationship adjusting unit is further configured to add the first user to the target schedule.

In some possible implementations, the target data further includes application data corresponding to a target application program. The association relationship adjusting unit is further configured to grant the first user an authority to use the target application program, or set the first user as an administrator of the target application program.

In some possible implementations, the target data further includes questionnaire data corresponding to a target questionnaire. The association relationship adjusting unit is further configured to grant the first user an authority to fill in the target questionnaire, or grant the first user an authority to manage the target questionnaire.

In some possible implementations, the acquisition unit is configured to display resource data and candidates of the second user, determine the target data in the resource data in response to a selection instruction, and determine the first user among the candidates.

An embodiment of the present disclosure further provides an electronic device, including:
one or more processors; and
a storage device on which one or more programs are stored, wherein
the one or more programs, when executed by the one or more processors, are configured to cause the one or more processors to implement the data processing method described in any of the embodiments or implementations above.

An embodiment of the present disclosure further provides a non-transient computer-readable storage medium having a computer program stored thereon, wherein the computer program, when executed by a processor, implements the data processing method described in any of the embodiments or implementations above.

An embodiment of the present disclosure further provides a computer program product, wherein the computer program product, when executed on a device, causes the device to perform the data processing method described in any of the embodiments or implementations above.

### BRIEF DESCRIPTION OF DRAWINGS

In order to clearly explain the embodiments of the present disclosure or the technical solution in the prior art, the drawings necessary for the description of the embodiments or the prior art will be briefly introduced below. Obviously, the drawings in the following description are only some of the embodiments recorded in the present disclosure, and other drawings can be obtained according to these drawings without creative work for those ordinary skilled in the art.

FIG. 1 is a flowchart of a data processing method provided by an embodiment of the present disclosure;

FIG. 2 is a schematic diagram of an exemplary application scenario provided by an embodiment of the present disclosure;

FIG. 3 is a schematic structural diagram of a data processing apparatus provided by an embodiment of the present disclosure; and

FIG. 4 is a schematic diagram of a basic structure of an electronic device provided by an embodiment of the present disclosure.

### DETAILED DESCRIPTION

Embodiments of the present disclosure will be described in more details below with reference to the accompanying drawings. Although some embodiments of the present disclosure are shown in the drawings, it should be understood that the present disclosure can be realized in various forms and should not be construed as limited to the embodiments set forth here. On the contrary, these embodiments are provided for a more thorough and complete understanding of the present disclosure. It should be understood that the drawings and embodiments of the present disclosure are only used for illustrative purposes, and are not used to limit the scope of protection of the present disclosure.

It should be understood that the steps described in the method embodiments of the present disclosure can be performed in a different order and/or in parallel. Furthermore, method embodiments may include additional steps and/or omit performing the illustrated steps. The scope of the present disclosure is not limited in this respect.

As used herein, the term “comprise/include” and variations thereof are opened inclusion, that is, “comprising/including, but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the description below.

The concepts of “first”, “second”, and the like mentioned in the present disclosure are only used to distinguish different devices, modules, or units, and are not used to limit the order or interdependence of functions performed by these devices, modules, or units.

Modifications referred to in this disclosure, such as “a/an” and “a plurality of”, are intended to be illustrative rather than limitative, and should be interpreted as “one or more” unless the context dictates otherwise, which should be appreciated by those skilled in the art.

In order to solve the problems in the prior art, the embodiments of the present disclosure provide a data processing method, which is described in details below with reference to the drawings accompanying the specification.

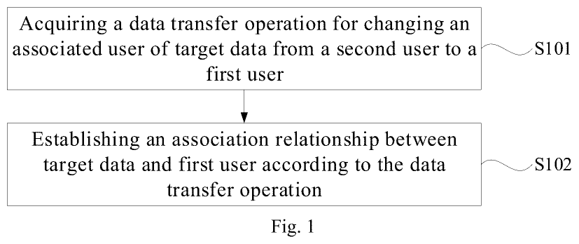

Referring to FIG. 1, FIG. 1 is an information interaction diagram of a data processing method provided by an embodiment of the present disclosure, which can be suitable for application scenarios in which users associated with target data are adjusted. In the embodiment of the present disclosure, the data processing method can be executed by a data processing apparatus, which can be realized by software. Alternatively, the data processing apparatus can be run on a client or a server. The client can be a client of a second user or a third user (see below for the introduction of the third user). Alternatively, the client can be a client of IM software, and the server can be a background server of IM software. The background server of IM software can have information interaction with the IM client.

As shown in FIG. 1, the method may include the following steps: S101, acquiring a data transfer operation.

In order to adjust the users associated with the target data, a data transfer operation can be triggered. Accordingly, the data processing apparatus can acquire the data transfer operation triggered by the user, so as to adjust the user associated with the data according to the data transfer operation.

In the embodiment of the present disclosure, the data transfer operation is used to adjust the associated user of the target data, for example, adjusting the associated user of the target data from the second user to the first user. The target data includes IM group chat data and/or video conference data. IM group chat data includes data related to IM group chat. Video conference data includes data related to video conference. The second user is the user associated with the target data before the association relationship adjustment operation is triggered. That is to say, before the data transfer operation is acquired, the IM group chat data is the data related to the IM group chat of the second user, and the video conference data is the data related to the video conference of the second user, which will be introduced below respectively.

First of all, the IM group chat data is introduced.

In the embodiment of the present disclosure, the IM group chat data may include an identifier of the IM group chat. Among them, the identifier of the IM group chat is used to uniquely identify the IM group chat. Group chat members in the IM group chat are all associated with the identifier of the IM group chat. That is to say, the user associated with the IM group chat may be a group chat user in the IM group chat. Therefore, if the target data includes the identifier of the IM group chat, adjusting the user associated with the target data is equivalent to adjusting the group chat member in the IM group chat. That is to say, if the IM group chat data includes the identifier of the IM group chat, the data transfer operation can be used to transfer the IM group chat of the second user to the first user.

Alternatively, the IM group chat data may include authority information of the IM group chat. Among them, the authority information of the IM group chat is used to indicate the authority of group members in the IM group chat. For example, the authority information of the IM group chat may include a group owner identifier and/or an administrator identifier. The group owner identifier is used to identify the user as the group owner of the IM group chat, and the administrator identifier is used to identify the user as the administrator of the IM group chat. That is to say, if the second user is the group owner or administrator of an IM group chat, the group owner/administrator of the IM group chat can be transferred to other users (such as the first user) by triggering the data transfer operation.

Optionally, the IM group chat data may also include data related to the IM group chat, such as the chat record data of the IM group chat and the related information of other group chat members in the IM group chat. Accordingly, if the IM group chat data includes the chat record data of the IM group chat, the associated user of the IM group chat data can view the chat record data of the IM group chat. If the IM group chat data includes the related information of other group chat members in the IM group chat, the associated user of the IM group chat data can view the related information of other group chat members in the IM group chat.

In an actual scenario, for the IM software used by enterprises, IM group chat can be classified into IM internal group chat and IM external group chat. The group chat members in the IM internal group chat are internal members of the enterprise. The group chat members in the IM external group chat include at least one external member of the enterprise. In the embodiment of the present disclosure, if the target data includes IM group chat data, the IM group chat data may be related data corresponding to the IM internal group chat or related data corresponding to the IM external group chat. For example, in some possible implementations, the IM internal group chat corresponding to the second user can be determined as the IM group chat whose association relationship needs to be adjusted, and the second user (or the third user described below) can manually select the IM external group chat as the IM group chat whose association relationship needs to be adjusted.

The IM group chat data has been introduced above, and the video conference data will be introduced below.

In the embodiment of the present disclosure, the video conference data may include at least one of the video of the video conference, the audio of the video conference or the text record of the video conference. The associated user of the video conference data can view or edit the video of the video conference, the audio of the video conference and the text record (if any) of the video conference. Optionally, participants participating in the video conference can be set as associated users of the video conference. That is to say, if the second user participates in a video conference, the related data of the video conference can be transferred to other users (such as the first user) by triggering the data transfer operation.

Among them, the video of the video conference can be obtained by means of video acquisition during the video conference. The audio of the video conference can be obtained by means of audio recording during the video conference. Optionally, the video of the video conference may include image data and audio data, or may only include image data. If the video of the video conference includes audio data, the video of the video conference may include the same audio data as the audio of the video conference. Accordingly, the audio of the video conference can be separated from the video of the video conference.

The text record of a video conference can be obtained by converting the audio of the video conference into text. Optionally, the text record of the video conference can also include the marking information added by the participants during the video conference.

In addition to the IM group chat data and the video conference data, the target data can also include other data, which will be introduced below respectively.

In some possible implementations, the target data may include document data. Among them, the document data may include one or more documents. The document can be a cloud document or a local document. If the document data includes a local document, the local document can be sent to the second user through the network after the association relationship of the target data is adjusted. The associated user of the document data has an authority to view the documents included in the document data. Optionally, the associated user of the document data may also have an authority to edit the document data.

In some possible implementations, the target data may also include schedule data. Among them, the schedule data refers to the schedule reserved on the calendar application. Schedule is used to remind associated users to do a certain job at a certain time. Before the data transfer operation is triggered, the associated user of the schedule data in the target data is the second user. Optionally, the schedule data in the target data may be a schedule reserved by the second user. That is to say, if the second user has reserved a schedule, the schedule can be transferred to other users (such as the first user) by triggering the data transfer operation. For example, a corresponding schedule is created on the calendar of the first user, and the schedule data related to the second user, such as schedule time, place, schedule content, participants and other information, is retained in the created schedule.

In some possible implementations, the target data may also include application data. The application data is data related to an application program, which may include, for example, authority information of the application program. Before the data transfer operation is triggered, the associated user of the application data in the target data is the second user. Optionally, the application data can be data such as the account and the password of the second user in the application program, and can also be used to indicate the authority of the second user to access the application program or manage the application program. That is to say, if the second user has an authority to access an application program or is an administrator of an application program, the above authority can be transferred to other users (such as the first user) by triggering the data transfer operation.

In some possible implementations, the target data may also include questionnaire data. Before the data transfer operation is triggered, the associated user of the questionnaire data in the target data is the second user. The questionnaire data may include the questionnaire created by the second user or the questionnaire to be completed by the second user. That is to say, if the second user has created a questionnaire or has not finished a questionnaire, the questionnaire can be transferred to other users (such as the first user) by triggering the data transfer operation.

The target data has been introduced above, and the data transfer operation for transferring the target data will be introduced below.

In the embodiment of the present disclosure, the data transfer operation is used to adjust the associated user of the target data from the second user to the first user. Optionally, the target data and the first user may be selected by the same user or different users. For example, in some possible implementations, the second user can select the target data, and then other users can select the first user and trigger the data transfer operation. The following is an example where the target data and the first user are determined by the same user.

In a first possible implementation, the data transfer operation is triggered by the second user.

The data transfer operation is used to adjust the associated user of the target data from the second user to the first user. That is to say, if the second user needs to transfer the target data to other users, the second user can determine the target data and the first user on the client and trigger the data transfer operation. Optionally, the client can be an IM client. Illustratively, in the scenario of employee post change, for example, resignation, post transfer or vacation, the second user with post change can select the target data so as to transfer the target data to other users.

For example, given that the second user has joined two IM group chats, i.e., IM group chat A and IM group chat B, on the IM software. Among them, IM group chat A is related to work, while IM group chat B has nothing to do with work. Then, when the second user leaves his/her job, the IM group chat A can be transferred to other users, and it's not necessary to transfer the IM group chat B to other users. Accordingly, the second user can determine the IM group chat data of the IM group chat A as the target data.

For another example, given that the second user has had two video conferences, i.e., video conference C and video conference D. The work corresponding to video conference C has been completed, and the work corresponding to video conference D has not been completed yet. Then, when the second user leaves his/her job, the video conference C can be transferred to other users, and it's not necessary to transfer the video conference D to other users. Accordingly, the second user can determine the video conference data corresponding to the video conference C as the target data.

In a second possible implementation, the data transfer operation is triggered by a third user.

First of all, the third user is introduced.

If the association relationship adjustment operation is used to adjust the user associated with the target data from the second user to the first user, the association relationship adjustment operation may be triggered by users other than the first user and the second user. In the embodiment of the present disclosure, the user who triggers the association relationship adjustment operation may be referred to as a third user.

Optionally, the third user may be a user responsible for managing the related data of the second user. For example, in the scenario of employee resignation, the second user may be a user who needs to resign, and the first user may be a user who is responsible for receiving the work of the second user. Accordingly, in the personnel relationship within the enterprise, the third user can be the leader of the second user, or the third user can be the person in charge of managing the personnel system in the enterprise to which the second user belongs.

In some possible implementations, the third user may be preconfigured. That is to say, which user is responsible for triggering the association relationship adjustment operation can be set in advance. For example, in the scenario of employee resignation, a user (i.e., the third user), who is responsible for triggering the association relationship adjustment operation when the employee resigns, can be set in the background system in advance. In this way, after the first user submits the resignation application, the third user can trigger the association relationship adjustment operation to adjust the user associated with the target data.

If the association relationship adjustment operation is triggered by a third user, the target data and/or the first user may be determined by the third user. That is to say, the third user can determine to which user the target data needs to be transferred from the second user, thus triggering the association relationship adjustment operation.

For example, the second user can initiate an application for transferring the data to other users. After viewing the application initiated by the second user, the third user can, firstly, determine the data to be transferred (that is, the target data), then determine which user the target data needs to be transferred to, and then trigger the corresponding association relationship adjustment operation. The association relationship adjustment operation includes the identifier of the first user, which is used to indicate that the target data needs to be associated with the first user.

In an actual scenario, it may need to adjust association relationships of a plurality of pieces of data. In such case, the third user can determine the user, corresponding to each piece of data in the plurality of pieces of data, for whom the association relationship adjustment needs to be rebuilt.

In the actual scenario, the third user can trigger the association relationship adjustment operation through a client corresponding to the third user. The client can be a client for adjusting the association relationship, such as an IM client of a third user. The IM client of the third user may include the client of the IM software logged by the third user, for example, the client of the IM software logged by the account of the third user. In this embodiment of the present disclosure, the client corresponding to the first user can be referred to as the first client, the client corresponding to the second user can be referred to as the second client, and the client corresponding to the third user can be referred to as the third client.

The application scenario of resignation is described by way of example. If the second user needs to leave his/her job or change his/her post, the second user can trigger a data transfer request on the second client. The identifier of the second user may be included in the data transfer request to indicate that the data transfer request was triggered by the second user. Optionally, the data transfer request may also include the identifier of candidate data. The candidate data is related data that can be transferred to other users. The candidate data may include the target data.

The background server of IM software can acquire the data transfer request sent by the second client and determine the third user corresponding to the second user according to the identifier of the second user in the data transfer request.

After determining the identifier of the third user, the background server of IM software can send a data transfer request to the third client. The data transfer request sent by the background server to the third client may include the related information of the candidate data and the identifier of the second user, so that the third client can display the related information of the candidate data and the identifier of the second user to the third user.

Optionally, if the third client is an IM client corresponding to the third user, the third client can prompt the third user to trigger the data transfer operation by generating a new IM message. For example, the third client can create a new IM session to prompt the third user to trigger the data transfer adjustment operation. And/or, the third client can also prompt the third user by using the existing session for reminding the third user to trigger the data transfer operation.

According to the content displayed by the third client, the third user can determine the target data and the first user. For example, if the data transfer request includes candidate data, the third user can determine which data of the candidate data belongs to the target data. In addition, the third user can also determine which user the target data needs to be transferred to, that is, determining the first user. After determining the first user, the third user can trigger the data transfer operation on the third client. The data transfer operation includes the identifier of the target data and the identifier of the first user, indicating that the associated user of the target data is adjusted to be the first user.

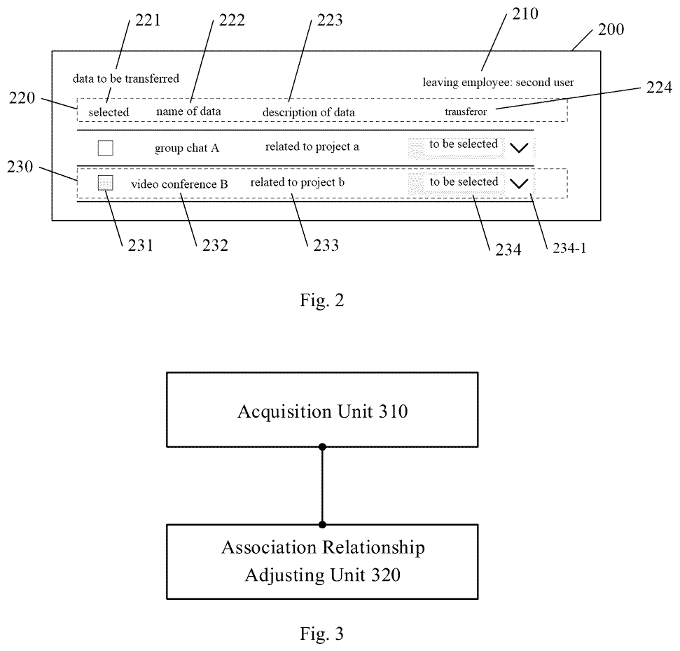

For example, the screen displayed by the third client may include a display area 200 as shown in FIG. 2. In the display mode shown in FIG. 2, the third client can display the display area 200. The display area 200 includes a user display area 210 and a title display area 220. The display area 200 further includes at least one data display area. In the implementation shown in FIG. 2, the display area 200 includes a data display area 230. The user display area 210 is used to display the related information of the second user, indicating that the content displayed in the display area 200 is obtained according to the association relationship transfer request triggered by the second user.

The title display area 220 includes a display sub-area 221, a display sub-area 222, a display sub-area 223 and a display sub-area 224. The title display area 220 is used to identify the content displayed in each of the display sub-areas in the data display area. The display sub-area 221 is used to indicate that the content displayed in the display sub-area, of the data display area, corresponding to the display sub-area 221 is the selected status of data. The display sub-area 222 is used to indicate that the content displayed in the display sub-area, of the data display area, corresponding to the data display area 222 is the name of the data. The display sub-area 223 is used to indicate that the content displayed in the display sub-area, of the data display area, corresponding to the display sub-area 223 is the descriptive information of the data. The display sub-area 224 is used to indicate that the content displayed in the display sub-area, of the data display area, corresponding to the display sub-area 224 is the user receiving the transferred data.

The data display area 230 includes a display sub-area 231, a display sub-area 232, a display sub-area 233 and a display sub-area 234. The display sub-area 231 corresponds to the display sub-area 221 and is used to display the selected status of the data to be transferred. The display sub-area 232 corresponds to the display sub-area 222 and is used to display the name of the data to be transferred. The display sub-area 233 corresponds to the display sub-area 223, and is used to display the description information of the data to be transferred. The display sub-area 234 corresponds to the display sub-area 224, and is used to display the user to whom the data to be transferred needs to be transferred.

In the implementation shown in FIG. 2, the data display area 230 corresponds to the video conference B. Accordingly, the display sub-area 231 can display the selected status of video conference data corresponding to video conference B, the display sub-area 232 can display the name of video conference B, and the description information displayed in the display sub-area 233 can indicate that video conference B is related to project b. The display sub-area 234 is used for the third user to select which user the related data of video conference B needs to be transferred to.

In the implementation shown in FIG. 2, the video conference data corresponding to video conference B is in the selected status, that is, the video conference data corresponding to video conference B is selected as target data and transferred to other users. In addition, the third user has not yet determined to which user the related data of video conference B needs to be transferred. Therefore, the display sub-area 234 may display the words “to be selected”.

The display sub-area 234 may include a control for triggering the association relationship transfer operation. For example, in the implementation shown in FIG. 2, the display sub-area 234 may include a drop-down control 234-1. A third user may trigger the drop-down control 234-1. After the operation for the drop-down control 234-1 triggered by the third user is acquired, an information bar can be displayed. The information bar can include related information of one or more users, and the users displayed in the information bar are users who can receive the related data of the video conference B. The third user can select one or more users, from the users displayed in the information bar, as the first user, to trigger the association relationship adjustment operation. Accordingly, the association relationship adjustment operation is used to adjust the user associated with the related data of the video conference B from the second user to the first user.

S102, establishing an association relationship between the target data and the first user according to the data transfer operation.

After acquiring the data transfer operation, the association relationship between the target data and the first user can be established according to the data transfer operation. In the embodiment of the present disclosure, the association relationship between the target data and the first user is used to indicate that the associated user of the target data is the first user, which can be referred to as the first association relationship.

In addition, a second association relationship can be deleted after the association relationship adjustment operation is acquired. The second association relationship is the association relationship between the target data and the second user, which is used to indicate that the associated user of the target data is the second user. In this way, the association relationship between the target data and the second user is deleted, and the association relationship between the target data and the first user is established, which is equivalent to adjusting the associated user of the target data from the second user to the first user.

According to the introduction above, the target data may include IM group chat data and/or video conference data. Accordingly, if the target data includes IM group chat data, the first association relationship may include an association relationship between the IM group chat data and the identifier of the first user. If the target data includes video conference data, the first association relationship may include an association relationship between the video conference data and the identifier of the first user, which will be introduced as below, respectively.

In a first possible implementation, the first association relationship includes the association relationship between the IM group chat data and the identifier of the first user.

If the first association relationship includes the association relationship between the IM group chat data and the identifier of the first user, it indicates that the first user is associated with the group chat corresponding to the IM group chat data. According to the introduction above, the IM group chat data includes the identifier of the IM group chat, and the first association relationship may include the association relationship between the identifier of the IM group chat and the identifier of the first user. Accordingly, after the first association relationship is established, the first user can be added as a group chat member of the IM group chat.

Optionally, the IM group chat data may also include the authority information of the IM group chat. Then, when the first association relationship is established, the authority information of the first user in the IM group chat can be adjusted according to the authority information of the second user in the IM group chat. For example, if the second user is the administrator of the IM group chat, the first user can be set as the administrator of the IM group chat. If the second user is the group owner of the IM group chat, the first user can be set as the group owner of the IM group chat.

Optionally, an adding instruction can be sent to the background server corresponding to the IM software, and the adding instruction is used to add the first user as a group chat member (or administrator or group owner) of the IM group chat corresponding to the target data. In some possible implementations, the user may need to be approved to join the IM group chat, then it can request for the first user to join the IM group chat corresponding to the target data.

For example, a request message can be generated. The request message includes the identifier of the IM group chat to be joined and the identifier of the first user, indicating that the first user requests to join the IM group chat. Then, a group joining request message can be sent to the background server corresponding to the IM software. After acquiring the group joining request message, the background server can query the management user according to the identifier of the IM group chat, and send the group joining request message to the IM client corresponding to the management user. The management user may include, for example, the group owner and/or the administrator of the IM group chat. After seeing the group joining request message through the IM client, the management user can choose to allow the first user to join the IM group chat or refuse the first user to join the IM group chat.

Optionally, the request message sent to the background server corresponding to the IM software may also include the identifier of the second user, indicating that the first user is to receive the group chat transferred by the second user. Accordingly, the group joining request message sent by the background server to the IM client corresponding to the management user may include remark information, which is used to indicate that the first user is to receive the group chat transferred by the second user. In this way, the management user can know the reason why the first user joins the IM group chat.

According to the introduction above, the IM group chat data can also include data related to the IM group chat, such as the chat record data of the IM group chat and the related information of other group chat members in the IM group chat. Accordingly, after the first association relationship is established, the first user has an authority to view the above-mentioned data related to the IM group chat. For example, the related authority information of the first user can be adjusted, which will not be described in details here.

In a second possible implementation, the first association relationship includes the association relationship between the video conference data and the identifier of the first user.

After the first association relationship is established, the authority information of the first user can be adjusted to grant the first user the authority to view the video conference data. For example, if the related data of the video conference includes video, audio or text records corresponding to the video conference, the authority of the first user to view the video conference data can be adjusted after the first association relationship is established, so that the first user can view the video, audio or text records (if any) of the video conference.

Optionally, after the first association relationship is established, the first user may also be granted with an authority to edit the video conference data. For example, if the related data of the video conference includes video, audio or text records corresponding to the video conference, the authority of the first user to edit the video conference data can be adjusted after the first association relationship is established, so that the first user can edit the video, audio or text records (if any) of the video conference.

According to the above introduction, in addition to the IM group chat data and the video conference data, the target data can also include other data. In the following, different implementations are introduced respectively.

In some possible implementations, the target data includes document data. Assuming that the document data corresponds to the target document, then the authority of the first user to view the target document can be adjusted after the first association relationship is established, so as to grant the first user the authority to view the target document. Optionally, the authority of the first user to edit the target document can also be adjusted to grant the first user the authority to edit the target document.

In some possible implementations, the target data includes schedule data. Assuming that the schedule data corresponds to the target schedule, then the target schedule can be added for the first user after the first association relationship is established. For example, the target schedule can be added in the schedule application of the first user. Optionally, the above-mentioned schedule application can be integrated into the IM client of the first user.

In some possible implementations, the target data includes application data. Assuming that the application data corresponds to the target application program, then the authority of the first user to use the target application program can be adjusted to grant the first user the authority to use the target application program. Optionally, the authority of the first user to edit the target application program can also be adjusted to grant the first user the authority to manage the target application program.

In some possible implementations, the target data may also include questionnaire data. Assuming that the questionnaire data corresponds to the target questionnaire, then if the target questionnaire is the questionnaire that the second user has not answered, the authority of the first user to answer the target questionnaire can be adjusted after the first association relationship is established, so as to grant the first user the authority to answer the target questionnaire; if the target questionnaire is a questionnaire created by the second user, the authority of the first user to manage the target questionnaire can also be adjusted to grant the first user the authority to manage the target questionnaire. Optionally, managing the target questionnaire may include sending the target questionnaire and/or viewing the response results of the target questionnaire.

The embodiment of the present disclosure provides a data processing method. For example, when the user associated with the target data needs to be adjusted, a data transfer operation can be acquired firstly. The data transfer operation is used to change the associated user of the target data from the second user to the first user. The target data includes IM group chat data and/or video conference data of the second user. After the data transfer operation is acquired, the association relationship between the target data and the first user can be established. That is to say, if it's intended to transfer the IM group chat data or video conference data of the second user to the first user, a data transfer operation can be triggered for the data that needs to be transferred (that is, the target data). In this way, the automatic transfer of data is realized, which is convenient for a user to adjust the users associated with IM group chat data or video conference data.

Based on the data processing method provided by the above method embodiments, an embodiment of the present disclosure further provides a data processing apparatus, which will be described below in conjunction with the drawings.

Referring to FIG. 3, which is a schematic structural diagram of a data processing apparatus provided by an embodiment of the present disclosure. As shown in FIG. 3, the data processing apparatus includes:
an acquisition unit 310, configured to acquire a data transfer operation for changing an associated user of target data from a second user to a first user, wherein the target data includes IM group chat data and/or video conference data of the second user; and an association relationship adjusting unit 320, configured to establish an association relationship between the target data and the first user according to the data transfer operation.

In some possible implementations, the association relationship adjusting unit 320 is further configured to delete an association relationship between the target data and the second user.

In some possible implementations, the target data includes the IM group chat data, and the IM group chat data includes the identifier of the target IM group chat. The association relationship adjusting unit 320 is, for example, configured to adjust the first user to be a group member, an administrator or a group owner of the target IM group chat.

In some possible implementations, the target data includes video conference data, which includes at least one of video, audio and text record of the video conference.

In some possible implementations, the association relationship adjusting unit 320 is, for example, configured to grant the first user an authority to access the video conference data or an authority to edit the video conference data.

In some possible implementations, the target data further includes document data corresponding to the target document. The association relationship adjusting unit 320 is further configured to grant the first user an authority to view the target document or an authority to edit the target document.

In some possible implementations, the target data further includes schedule data corresponding to the target schedule. The association relationship adjusting unit 320 is further configured to add the first user to the target schedule.

In some possible implementations, the target data also includes application data corresponding to the target application program. The association relationship adjusting unit 320 is further configured to grant the first user an authority to use the target application program, or to set the first user as the administrator of the target application program.

In some possible implementations, the target data further includes questionnaire data corresponding to the target questionnaire. The association relationship adjusting unit 320 is further configured to grant the first user an authority to fill in the target questionnaire, or grant the first user the authority to manage the target questionnaire.

In some possible implementations, the acquisition unit 310 is, for example, configured to display resource data and candidates of the second user, determine the target data in the resource data in response to a selection instruction, and determine the first user among the candidates.

Based on the data processing method provided by the above method embodiments, the present disclosure further provides an electronic device, which includes: one or more processors; and a storage device having one or more programs stored thereon, wherein the one or more programs, when executed by the one or more processors, cause the one or more processors to implement the data processing method as described in any of the above embodiments.

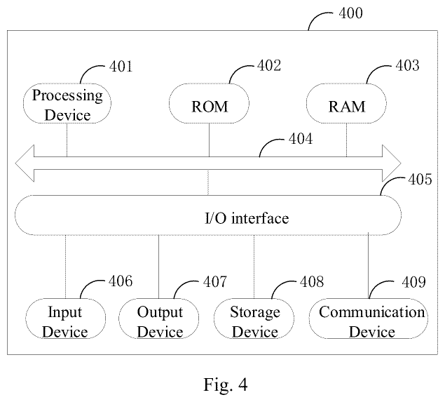

Reference is now made to FIG. 4, which shows a schematic structural diagram of an electronic device 400 suitable for implementing an embodiment of the present disclosure. The terminal device in the embodiment of the present disclosure may include, but is not limited to, mobile terminals such as mobile phones, laptops, digital broadcast receivers, personal digital assistants (PDAs), Tablets (PADs), portable multimedia players (PMPs), vehicle-mounted terminals (such as vehicle-mounted navigation terminals), etc., and regular terminals such as digital televisions (TVs), desktop computers, etc. The electronic device shown in FIG. 4 is only an example, and should not bring any limitation to the functions and application scope of the embodiments of the present disclosure.

As shown in FIG. 4, an electronic device 400 may include a processing device (such as a central processing unit, a graphics processor, etc.) 401, which may perform various appropriate actions and processes according to a program stored in a read-only memory (ROM) 402 or a program loaded from a storage device 408 into a random-access memory (RAM) 403. In the RAM 403, various programs and data required for the operation of the electronic device 400 are also stored. The processing device 401, the ROM 402 and the RAM 403 are connected to each other through a bus 404. An input/output (I/O) interface 405 is also connected to the bus 404.

Generally, the following devices can be connected to the I/O interface 405: an input device 408 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to perform wireless or wired communication with other devices to exchange data. Although FIG. 4 shows an electronic device 400 with various devices, it should be understood that it is not required to implement or have all the devices as shown. More or fewer devices may alternatively be implemented or provided.

In particular, according to an embodiment of the present disclosure, the process described above with reference to the flowcharts can be implemented as a computer software program. For example, an embodiment of the present disclosure includes a computer program product including a computer program carried on a non-transient computer-readable medium, the computer program contains program codes for executing the method shown in the flowcharts. In such an embodiment, the computer program can be downloaded and installed from the network through the communication device 409, or installed from the storage device 408, or installed from the ROM 402. The computer program, when executed by the processing device 401, implements the above functions defined in the method of the embodiments of the present disclosure.

The electronic device provided by the embodiment of the present disclosure belongs to the same inventive concept as the data processing method provided by the above embodiments, the technical details not described particularly in this embodiment can be found in the above embodiments, and this embodiment has the same beneficial effects as the above embodiments.

Based on the data processing method provided by the above method embodiments, the embodiment of the present disclosure further provides a computer-readable medium on which a computer program is stored, wherein the program, when executed by a processor, implements the data processing method as described in any of the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate or transmit a program used by or in combination with an instruction execution system, apparatus, or device. The program codes contained on the computer-readable medium may be transmitted by using any suitable medium, including but not limited to an electric wire, a fiber-optic cable, radio frequency (RF) and the like, or any appropriate combination of them.

In some embodiments, the client and the server may communicate with any network protocol currently known or to be researched and developed in the future, such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs that, when executed by the electronic device, cause the electronic device to perform the data processing method as described above.

Computer program codes for performing the operations of the present disclosure may be written in one or more programming languages or a combination thereof, including but not limited to object-oriented programming languages such as Java, Smalltalk, C++, and conventional procedural programming languages such as “C” or similar programming languages. The program codes may be executed entirely on the user's computer, partly on the user's computer, as a stand-alone software package, partly on the user's computer and partly on a remote computer, or entirely on a remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the figures illustrate the architecture, functionality, and operations of possible implementations of systems, methods, and computer program products according to various embodiments of the present disclosure. In this regard, each block in the flowchart or block diagrams may represent a module, a program segment, or a portion of code which contains one or more executable instructions for implementing specified logic functions. It is also to be noted that, in some alternative implementations, the functions labeled in the block may be performed in a sequence different from those labeled in the figures. For example, two blocks shown one after another may actually be executed substantially in parallel, or they may sometimes be executed in a reverse order, depending on the functionality involved. It will also be noted that each block of the block diagram and/or flowchart, and combinations of blocks in the block diagram and/or flowchart illustration, can be implemented by special purpose hardware-based systems that perform the specified functions or operations, or can be implemented by using a combination of specialized hardware and computer instructions.

The units described in the embodiment of the present disclosure can be realized by software or hardware. Among them, the name of the unit/module does not limit the unit itself in some cases. For example, the voice data acquisition module can also be described as a “data acquisition module”.

The functions described above in the present disclosure may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium, which may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

It should be noted that each embodiment in this specification is described in a progressive way, and each embodiment focuses on the differences from other embodiments, so the same and similar parts between various embodiments can be referred to each other. As for the system or device disclosed in the embodiment, because it corresponds to the method embodiment, the description is relatively simple, and the related contents can be found in the description of the method embodiment.

It should be understood that in the present disclosure, “at least one (item)” means one or more, and “a plurality of” means two or more. “and/or” is used to describe the relationship of related objects, indicating that there can be three kinds of relationships. For example, “A and/or B” can indicate that there are three cases of only A, only B, and both A and B, where A and B can be singular or plural. The character “/” generally indicates that the related objects are in an OR relationship. “At least one of the following (items)” or its similar expression refers to any combination of these items, including any combination of a single item or plural items. For example, “at least one of a, b or c” can be used to indicate: “a and b”, “a and c”, “b and c”, or “a and b and c”, where a, b and c can be in a single form or plural form.

It should also be noted that in the present disclosure, relational terms such as “first” and “second” are only used to distinguish one entity or operation from another entity or operation, and do not necessarily require or imply that there is any such actual relationship or order between these entities or operations. Moreover, the terms “comprising/including”, “containing” or any other variation thereof are intended to cover non-exclusive inclusion, so that a process, method, article or equipment including a series of elements includes not only those elements, but also other elements not explicitly listed or elements inherent to such process, method, article or equipment. Without further restrictions, an element defined by the phrase “comprising/including one/a/an” does not exclude the existence of other identical elements in the process, method, article or equipment including the element.

The foregoing description of the disclosed embodiments enables those skilled in the art to implement or use the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments shown herein, but is to be in accordance with the widest scope consistent with the principles and novel features disclosed herein.

1. A data processing method, comprising:
acquiring a data transfer operation for changing an associated user of target data from a second user to a first user, wherein the target data comprises IM group chat data and/or video conference data of the second user; and
establishing an association relationship between the target data and the first user according to the data transfer operation.

2. The method according to claim 1, further comprising:
deleting an association relationship between the target data and the second user.

3. The method according to claim 1, wherein the target data comprises the IM group chat data, and the IM group chat data comprises an identifier of a target IM group chat,
the establishing the association relationship between the target data and the first user according to the data transfer operation comprises:
adjusting the first user to be a group member, an administrator or a group owner of the target IM group chat.

4. The method according to claim 1, wherein the target data comprises the video conference data, and the video conference data comprises at least one of a video of the video conference, an audio of the video conference or a text record of the video conference.

5. The method according to claim 1, wherein the establishing the association relationship between the target data and the first user according to the data transfer operation comprises:
granting the first user an authority to access the video conference data or an authority to edit the video conference data.

6. The method according to claim 1, wherein the target data further comprises document data corresponding to a target document;
the establishing the association relationship between the target data and the first user according to the data transfer operation comprises:
granting the first user an authority to view the target document or an authority to edit the target document.

7. The method according to claim 1, wherein the target data further comprises schedule data corresponding to a target schedule;
the establishing the association relationship between the target data and the first user according to the data transfer operation comprises:
adding the first user to the target schedule.

8. The method according to claim 1, wherein the target data further comprises application data corresponding to a target application program;
the establishing the association relationship between the target data and the first user according to the data transfer operation comprises:
granting the first user an authority to use the target application program, or setting the first user as an administrator of the target application program.

9. The method according to claim 1, wherein the target data further comprises questionnaire data corresponding to a target questionnaire;
the establishing the association relationship between the target data and the first user according to the data transfer operation comprises:
granting the first user an authority to fill in the target questionnaire, or granting the first user an authority to manage the target questionnaire.

10. The method according to claim 1, wherein before acquiring the data transfer operation, the method further comprises:
displaying resource data and candidates of the second user;
determining the target data in the resource data in response to a selection instruction, and determining the first user among the candidates.

11. An electronic device, comprising:
one or more processors; and
a storage device on which one or more programs are stored, wherein
the one or more programs, when executed by the one or more processors, are configured to cause the one or more processors to implement a data processing method, comprising:
acquiring a data transfer operation for changing an associated user of target data from a second user to a first user, wherein the target data comprises IM group chat data and/or video conference data of the second user; and
establishing an association relationship between the target data and the first user according to the data transfer operation.

12. The electronic device according to claim 11, wherein the data processing method further comprises:
deleting an association relationship between the target data and the second user.

13. The electronic device according to claim 11, wherein in the data processing method, the target data comprises the IM group chat data, and the IM group chat data comprises an identifier of a target IM group chat,
the establishing the association relationship between the target data and the first user according to the data transfer operation comprises:
adjusting the first user to be a group member, an administrator or a group owner of the target IM group chat.

14. The electronic device according to claim 11, wherein in the data processing method, the target data comprises the video conference data, and the video conference data comprises at least one of a video of the video conference, an audio of the video conference or a text record of the video conference.

15. The electronic device according to claim 11, wherein in the data processing method, the establishing the association relationship between the target data and the first user according to the data transfer operation comprises:
granting the first user an authority to access the video conference data or an authority to edit the video conference data.

16. The electronic device according to claim 11, wherein in the data processing method, the target data further comprises document data corresponding to a target document;
the establishing the association relationship between the target data and the first user according to the data transfer operation comprises:
granting the first user an authority to view the target document or an authority to edit the target document.

17. The electronic device according to claim 11, wherein in the data processing method, the target data further comprises schedule data corresponding to a target schedule;
the establishing the association relationship between the target data and the first user according to the data transfer operation comprises:
adding the first user to the target schedule.

18. The electronic device according to claim 11, wherein in the data processing method, the target data further comprises application data corresponding to a target application program;
the establishing the association relationship between the target data and the first user according to the data transfer operation comprises:
granting the first user an authority to use the target application program, or setting the first user as an administrator of the target application program.

19. The electronic device according to claim 11, wherein in the data processing method, the target data further comprises questionnaire data corresponding to a target questionnaire;
the establishing the association relationship between the target data and the first user according to the data transfer operation comprises:
granting the first user an authority to fill in the target questionnaire, or granting the first user an authority to manage the target questionnaire.

20. A non-transient computer-readable storage medium having a computer program stored thereon, wherein the computer program, when executed by a processor, implements a data processing method, comprising:
acquiring a data transfer operation for changing an associated user of target data from a second user to a first user, wherein the target data comprises IM group chat data and/or video conference data of the second user; and
establishing an association relationship between the target data and the first user according to the data transfer operation.
